(19) United States
(12) Patent Application Publication
(10) Pub. No.: US 2019/0322843 A1
(43) Pub. Date: Oct. 24, 2019

(54) TIRE RUBBER COMPOSITION AND TIRE, AND MANUFACTURING METHODS THEREOF

(71) Applicant: TOYO TIRE CORPORATION, Itami-shi, Hyogo (JP)

(72) Inventor: Fumihiko Nakamura, Itami-shi (JP)

(73) Assignee: TOYO TIRE CORPORATION, Itami-shi, Hyogo (JP)

(21) Appl. No.: 16/349,728

(22) PCT Filed: Oct. 24, 2017
(86) PCT No.: PCT/JP2017/038311

§ 371 Date: May 14, 2019

(30) Foreign Application Priority Data
Dec. 20, 2016 (JP) 2016-246817

(51) Int. Cl. C08L 9/00; C08K 7/28; C08L 7/00; B60C 1/00; C03C 3/087; C03C 11/00

(52) U.S. Cl. CPC C08L 9/00; C08K 7/28; C08L 7/00; C08K 2201/003; C03C 3/087; C03C 11/007; B60C 1/0016

(57) ABSTRACT

A tire rubber composition in accordance with the present disclosure comprises diene rubber and comprises porous foamed glass particles of porosity not greater than 80%. A tire rubber composition manufacturing method in accordance with the present disclosure comprises an operation in which porous foamed glass particles of porosity not greater than 80% fabricated using foaming agent comprising powdered seashells is kneaded into diene rubber.

### TECHNICAL FIELD

The present disclosure relates to a tire rubber composition and to a tire, and to manufacturing methods thereof.

### BACKGROUND ART

There is art for imparting tread rubber with biting action and for improving performance on ice and snow. Patent Reference No. 1, for example, discloses art in which siliceous hollow microparticles are used to cause tread rubber to have biting action. Patent Reference No. 2 discloses art in which powdered eggshells are used to cause tread rubber to have biting action.

However, the particles that impart these with biting action generally cause reduction in the wear resistance of the tire.

### PRIOR ART REFERENCES

### Patent References

PATENT REFERENCE NO. 1: Japanese Patent Application Publication Kokai No. 2010-150483

PATENT REFERENCE NO. 2: Japanese Patent Application Publication Kokai No. 2010-59248

### SUMMARY OF INVENTION

### Means for Solving Problem

A tire rubber composition in accordance with the present disclosure comprises diene rubber and comprises porous foamed glass particles of porosity not greater than 80%.

A tire rubber composition manufacturing method in accordance with the present disclosure comprises an operation in which porous foamed glass particles of porosity not greater than 80% fabricated using foaming agent comprising powdered seashells is kneaded into diene rubber.

### EMBODIMENTS FOR CARRYING OUT INVENTION

It is an object of the present disclosure to provide a tire rubber composition that is not only capable of improving performance on ice and snow but that is also able to simultaneously achieve performance on ice and snow as well as wear resistance. It is moreover an object of the present disclosure to provide a method for manufacturing such a tire rubber composition.

A tire rubber composition in accordance with the present disclosure comprises diene rubber and comprises porous foamed glass particles of porosity not greater than 80%. Such foamed glass particles impart the tire with biting action and water absorbing capability, and make it possible to increase the tire's braking performance on ice and stability in handling in snow. Moreover, because foamed glass particles have excellent rubber impregnation characteristics and tend not to be dislodged from the tire, a tire that employs foamed glass particles will have excellent wear resistance.

It is preferred that foamed glass particles be present in an amount that is not less than 0.5 part by mass for every 100 parts by mass of diene rubber. Below 0.5 part by mass, there tends to be too little benefit in terms of improvement in braking performance on ice and stability in handling in snow. It is preferred from the standpoint of ensuring adequate wear resistance that foamed glass particles be present in an amount that is not greater than 20 parts by mass for every 100 parts by mass of diene rubber.

It is preferred that average particle diameter of the foamed glass particles be less than 1000 μm. Tires employing foamed glass particles of average particle diameter 1000 μm or higher tend to have inferior wear resistance.

It is preferred that the major foamed glass particle components be SiO₂, CaO, and Na₂O.

It is preferred that the tire rubber composition of the present disclosure further comprise at least one species selected from among the group consisting of pulverized porous carbide, porous cellulose particles, and vegetative granules. These will make it possible to further improve the tire's performance on ice and snow.

A tire in accordance with the present disclosure is provided with a tread that is made up of a tire rubber composition in accordance with the present disclosure.

A tire rubber composition manufacturing method in accordance with the present disclosure comprises an operation in which porous foamed glass particles of porosity not greater than 80% fabricated using foaming agent comprising powdered seashells is kneaded into diene rubber. Such foamed glass particles have excellent water absorbing capability and biting action, provide a high degree of surface irregularity, and have excellent rubber impregnation characteristics. This is thought to be due to bubbles formed by carbon dioxide gas produced as a result of decomposition of calcium carbonate within the powdered seashells, and due to micropores formed as a result of burning of humic acid within the powdered seashells.

It is preferred that at least inorganic waste material and the foregoing foaming agent serve as raw materials for the foamed glass particles. Where this is the case, this will be environmentally friendly, as it will permit reuse of inorganic waste material and powdered seashells.

A tire manufacturing method in accordance with the present disclosure comprises a tire rubber composition manufacturing method in accordance with the present disclosure.

### Embodiment 1

The present disclosure will now be described in terms of a first embodiment.

A tire rubber composition in accordance with the first embodiment comprises diene rubber. As the diene rubber, natural rubber, isoprene rubber, butadiene rubber, styrene-butadiene rubber, styrene-isoprene copolymer rubber, butadiene-isoprene copolymer rubber, styrene-isoprene-butadiene copolymer rubber, and so forth may be cited as examples. Any one of these may be used, or any two or more of these may be used. It is preferred that the diene rubber comprise natural rubber and butadiene rubber. It is preferred that the amount of natural rubber be not less than 30 mass %, and more preferred that this be not less than 40 mass %, per 100 mass % of the diene rubber. It is preferred that the upper limit of the range in values for the amount of the natural rubber be 80 mass %, and more preferred that this be 70 mass %, per 100 mass % of the diene rubber. It is preferred that the amount of butadiene rubber be not less than 20 mass %, and more preferred that this be not less than 30 mass %, per 100 mass % of the diene rubber. It is preferred that the upper limit of the range in values for the amount of the butadiene rubber be 70 mass %, and more preferred that this be 60 mass %, per 100 mass % of the diene rubber.

A tire rubber composition in accordance with the first embodiment comprises porous foamed glass particles of porosity not greater than 80%. Such foamed glass particles impart the tire with biting action and water absorbing capability, and make it possible to increase braking performance on ice and stability in handling in snow. Moreover, the foamed glass particles have excellent rubber impregnation characteristics and tend not to be dislodged from the tire. When porosity is greater than 80%, there is a tendency for the pores within the foamed glass particles to collapse and there is a possibility that there will be too little benefit in terms of improvement in braking performance on ice and stability in handling in snow. It is preferred that porosity of the foamed glass particles be not greater than 75%, and more preferred that this be not greater than 70%. It is preferred that the lower limit of the range in values for the porosity of the foamed glass particles be 56%. Porosity of foamed glass particles is calculated by the method described at the working examples. The lower limit of the range in values for the true density of the foamed glass particles might, for example, be 2.2 g/cm³, 2.3 g/cm³, or 2.4 g/cm³. The upper limit of the range in values for the true density of the foamed glass particles might, for example, be 2.8 g/cm³, 2.7 g/cm³, or 2.6 g/cm³.

It is preferred that average particle diameter of the foamed glass particles be less than 1000 μm. Tires employing foamed glass particles of average particle diameter 1000 μm or higher tend to have inferior wear resistance. It is more preferred that average particle diameter of the foamed glass particles be not greater than 500 μm. The lower limit of the range in values for the average particle diameter of the foamed glass particles might, for example, be 5 μm, 50 μm, 100 μm, or the like. The average particle diameter of the foamed glass particles is the value obtained by adding the average length along the major axis of the foamed glass particles to the average length along the minor axis of the foamed glass particles and dividing this by two. Average length along the major axis and average length along the minor axis are both determined through microscopic observation of foamed glass particles, an image being obtained, and length along the major axis and length along the minor axis being measured for 100 foamed glass particles.

It is preferred that the major foamed glass particle components be SiO₂, CaO, and Na₂O. The total of SiO₂, CaO, and Na₂O per 100% of all foamed glass particle components combined might, for example, be not less than 90%, it being preferred that this be not less than 92%, and it being more preferred that this be not less than 94%. The upper limit of the range in values for the total of SiO₂, CaO, and Na₂O per 100% of all components thereof combined might, for example, be 96%. SiO₂ might be not less than 60% per 100% of all components thereof combined. The upper limit of the range in values for SiO₂ might, for example, be 70%. CaO might be not less than 20% per 100% of all components thereof combined. Na₂O might be not less than 6% per 100% of all components thereof combined. As foamed glass particle components, besides SiO₂, CaO, and Na₂O, it is also possible to cite K₂O, Al₂O₃, Fe₂O₃, and so forth as examples.

The foamed glass particles may be fabricated using foaming agent comprising powdered seashells, and at least inorganic waste material and foaming agent comprising powdered seashells may serve as raw materials therefor. For example, foamed glass particles may be fabricated by a procedure in which powdered inorganic waste material and foaming agent comprising powdered seashells are mixed together, and this is fired and pulverized, and, where necessary, grading of the particulate is carried out. Foamed glass particles obtained in accordance with such a procedure will have excellent water absorbing capability and biting action, provide a high degree of surface irregularity, and have excellent rubber impregnation characteristics. This is thought to be due to bubbles formed by carbon dioxide gas produced as a result of decomposition of calcium carbonate within the powdered seashells, and due to micropores formed as a result of burning of humic acid within the powdered seashells. Depending on the type of seashells, it may be expected that there will be an effect whereby fibers within seashells may reinforce bubbles and may prevent bursting of bubbles. As seashells, those of blood clams may be cited as an example. As inorganic waste material, glassy waste material is preferred, it being possible to cite discarded glass bottles as an example.

For every 100 parts by mass of diene rubber, it is preferred that foamed glass particles be present in an amount that is not less than 0.5 part by mass, and more preferred that this be not less than 1 part by mass. Below 0.5 part by mass, there tends to be too little benefit in terms of improvement in braking performance on ice and stability in handling in snow. It is preferred from the standpoint of ensuring adequate wear resistance that, for every 100 parts by mass of diene rubber, foamed glass particles be present in an amount that is not greater than 20 parts by mass, more preferred that this be not greater than 15 parts by mass, and still more preferred that this be not greater than 10 parts by mass.

A tire rubber composition in accordance with the first embodiment may further comprise pulverized porous carbide. Pulverized porous carbide may be fabricated by a procedure in which porous carbide obtained by carburization of wood, bamboo, and/or other such vegetation is pulverized. As porous carbide, bamboo charcoal is preferred. The 90 vol % particle diameter (hereinafter “D90”) of the pulverized porous carbide might, for example, be 10 μm to 500 μm. D90 refers to the particle diameter at 90% of the integral of the (volume-based) particle size distribution as measured by the laser diffraction/scattering method.

A tire rubber composition in accordance with the first embodiment may further comprise porous cellulose particles. Wood pulp may serve as raw material for the porous cellulose particles. It is preferred that the ratio of the length of the major axis to the length of the minor axis (i.e., major axis length/minor axis length) of the porous cellulose particles be 1 to 2, and more preferred that this be 1.0 to 1.5. The ratio of the length of the major axis to the length of the minor axis is determined by using a microscopic image to measure length along the major axis and length along the minor axis for 100 porous cellulose particles, and calculating the average major axis length and the average minor axis length thereof. It is preferred that average particle diameter of the porous cellulose particles be not greater than 1000 μm, and more preferred that this be not greater than 800 μm. The lower limit of the range in values for the average particle diameter of the porous cellulose particles might, for example, be 100 μm, 200 μm, or the like. Average particle diameter is the value obtained by adding average major axis length to the average minor axis length and dividing this by two. It is preferred that the porosity of the porous cellulose particles be 75% to 95%. Porosity of the porous cellulose particles is determined by using the following formula. Here, the true specific gravity of cellulose is 1.5.

Porosity[%]={1−(bulk specific gravity[g/ml] of sample)/(true specific gravity[g/ml] of sample)}×100

A tire rubber composition in accordance with the first embodiment may further comprise vegetative granules. As vegetative granules, pulverized seed hulls, pulverized fruit pits, pulverized grain, pulverized grain heartwood, and so forth may be cited as examples. As vegetative granules, pulverized walnut pits are preferred. It is preferred that the D90 of the vegetative granules be not less than 100 μm, more preferred that this be not less than 150 μm, and still more preferred that this be not less than 200 μm. The upper limit of the range in values for the D90 of the vegetative granules might, for example, be 600 μm, it being preferred that this be 500 μm, and it being more preferred that this be 400 μm. The vegetative granules may be subjected to surface treatment with rubber adhesion promoter.

For every 100 parts by mass of diene rubber, it is preferred that foamed glass particles, pulverized porous carbide, porous cellulose particles, and vegetative granules be present in a combined amount that is not less than 0.5 part by mass, and more preferred that this be not less than 1 part by mass. For every 100 parts by mass of diene rubber, the upper limit of the range in values for the combined amount thereof might, for example, be 20 parts by mass, 15 parts by mass, 10 parts by mass, or the like.

A tire rubber composition in accordance with the first embodiment further comprises carbon black. It is preferred that the carbon black be of the SAF type, ISAF type, or HAF type. For every 100 parts by mass of diene rubber, it is preferred that the amount of carbon black be not less than 10 parts by mass, and more preferred that this be not less than 15 parts by mass. For every 100 parts by mass of diene rubber, the upper limit of the range in values for the amount of carbon black might, for example, be 80 parts by mass or 50 parts by mass.

A tire rubber composition in accordance with the first embodiment further comprises silica. It is preferred that the BET specific surface area of the silica be not less than 90 m²/g, and more preferred that this be not less than 150 m²/g. It is preferred that the upper limit of the range in values for the BET specific surface area of the silica be 250 m²/g, and more preferred that this be 220 m²/g. The BET specific surface area of the silica is measured in accordance with the BET method described at JIS K6430. For every 100 parts by mass of diene rubber, it is preferred that the amount of silica be not less than 10 parts by mass, and more preferred that this be not less than 15 parts by mass. For every 100 parts by mass of diene rubber, the upper limit of the range in values for the amount of silica might, for example, be 50 parts by mass.

For every 100 parts by mass of diene rubber, it is preferred that the combined amount of carbon black and silica be not less than 10 parts by mass, more preferred that this be not less than 20 parts by mass, and still more preferred that this be not less than 30 parts by mass. For every 100 parts by mass of diene rubber, the upper limit of the range in values for the combined amount of carbon black and silica might, for example, be 150 parts by mass, 100 parts by mass, or 80 parts by mass.

A tire rubber composition in accordance with the first embodiment further comprises silane coupling agent. As silane coupling agent, bis(3-triethoxysilylpropyl)tetrasulfide, bis(3-triethoxysilylpropyl)disulfide, bis(2-triethoxysilylethyl)tetrasulfide, bis(4-triekitoshisilylbutyl)disulfide, bis(3-trimethoxysilylpropyl)tetrasulfide, bis(2-trimethoxysilylethyl)disulfide, and other such sulfide silanes, γ-mercaptopropyltrimethoxysilane, γ-mercaptopropyltriethoxysilane, mercaptopropylmethyldimethoxysilane, mercaptopropyldimethylmethoxysilane, mercaptoethyltriethoxysilane, and other such mercaptosilanes, 3-octanoylthio-1-propyltriethoxysilane, 3-propionylthiopropyltrimethoxysilane, and other such protected mercaptosilanes may be cited as examples. For every 100 parts by mass of silica, it is preferred that the amount of silane coupling agent be not less than 1 part by mass, and more preferred that this be not less than 5 parts by mass. For every 100 parts by mass of silica, the upper limit of the range in values for the amount of silane coupling agent might, for example, be 20 parts by mass, 15 parts by mass, or the like.

A tire rubber composition in accordance with the first embodiment further comprises vulcanizing agent. As vulcanizing agent, powdered sulfur, precipitated sulfur, colloidal sulfur, insoluble sulfur, high dispersing sulfur, and the like may be cited as examples. It is preferred that the amount of vulcanizing agent, expressed as equivalent sulfur content, be not less than 0.1 part by mass, and more preferred that this be not less than 1 part by mass, for every 100 parts by mass of diene rubber. For every 100 parts by mass of diene rubber, the upper limit of the range in values for the amount of vulcanizing agent might, for example, be 10 parts by mass or 5 parts by mass.

A tire rubber composition in accordance with the first embodiment further comprises vulcanization accelerator. As vulcanization accelerator, sulfenamide-type vulcanization accelerator, thiuram-type vulcanization accelerator, thiazole-type vulcanization accelerator, thiourea-type vulcanization accelerator, guanidine-type vulcanization accelerator, dithiocarbamate-type vulcanization accelerator, and so forth may be cited as examples. For every 100 parts by mass of diene rubber, it is preferred that the amount of vulcanization accelerator be not less than 0.1 part by mass, and more preferred that this be not less than 0.5 part by mass. For every 100 parts by mass of diene rubber, the upper limit of the range in values for the amount of vulcanization accelerator might, for example, be 7 parts by mass or 5 parts by mass.

A tire rubber composition in accordance with the first embodiment may further comprise oil, zinc oxide, stearic acid, antioxidant, wax, and/or the like. As antioxidant, aromatic-amine-type antioxidant, amine-ketone-type antioxidant, monophenol-type antioxidant, bisphenol-type antioxidant, polyphenol-type antioxidant, dithiocarbamate-type antioxidant, thiourea-type antioxidant, and the like may be cited as examples.

A tire rubber composition in accordance with the first embodiment may be favorably employed in the tread of a tire, and may be favorably employed in the tread of a studless tire, snow tire, or other such winter tire. Where a tire rubber composition in accordance with the first embodiment is employed in a tire having a tread possessing a structure in which different compositions are employed at the cap and the base thereof, it may be favorably employed in the tread cap thereof.

A method for manufacturing a tire rubber composition in the context of the first embodiment comprises an operation in which a mixer is used to cause foamed glass particles to be kneaded into diene rubber to obtain a mixture. At this operation, carbon black, silica, oil, zinc oxide, stearic acid, antioxidant, wax, and/or the like may be kneaded into diene rubber together with foamed glass particles. As the mixer, internal mixers, open roll mills, and the like may be cited as examples. As an internal mixer, Banbury mixers, kneaders, and the like may be cited as examples.

The method for manufacturing the tire rubber composition in the context of the first embodiment further comprises an operation in which a mixer is used to cause vulcanizing agent and vulcanization accelerator to be kneaded into the mixture to obtain a rubber composition. As the mixer, internal mixers, open roll mills, and the like may be cited as examples. As an internal mixer, Banbury mixers, kneaders, and the like may be cited as examples.

A method for manufacturing a tire in the context of the first embodiment comprises an operation in which a green tire provided with a tread made up of the rubber composition is made. The method for manufacturing the tire in the context of the first embodiment further comprises an operation in which the green tire is heated.

### WORKING EXAMPLES

Working examples in accordance with the present disclosure are described below.

Rubber and compounding ingredients are indicated below.

| | |
|---|---|
| Natural rubber | RSS #3 |
| Butadiene rubber | “BR01” manufactured by JSR Corporation |
| Carbon black | “SEAST KH” manufactured by Tokai Carbon |
| | Co., Ltd. (N339) |
| Silica | “Nipsil AQ” manufactured by Tosoh Silica |
| | Corporation |
| Coupling agent | “Si 75” manufactured by Degussa |
| Paraffin oil: | “Process P200” manufactured by JOMO |
| Stearic acid | “LUNAC S-20” manufactured by Kao |
| | Corporation |
| Zinc oxide | “Zinc Oxide No. 1” manufactured by Mitsui |
| | Mining & Smelting Co., Ltd. |
| Antioxidant | “Antigen 6C” manufactured by manufactured by |
| | Sumitomo Chemical Co., Ltd. |
| Wax | “OZOACE 0355” manufactured by Nippon |
| | Seiro Co., Ltd. |
| Vegetative granules | “SOFT GRIT #46” manufactured by Nippon |
| | Walnut Co., Ltd. (crushed walnut shells; D90 = |
| | 300 μm) |
| Porous cellulose | “Viscopearl-Mini” manufactured by Rengo Co., |
| particles | Ltd. (average particle diameter 700 μm) |
| Foamed Glass | Foamed glass particles having an average |
| Particles 1 | particle diameter of 100 μm to 300 μm and a |
| | porosity of 62% fabricated in accordance with |
| | Fabrication Example 1 |
| Foamed Glass | Foamed glass particles having an average |
| Particles 2 | particle diameter of 300 μm to 500 μm and a |
| | porosity of 65% fabricated in accordance with |
| | Fabrication Example 1 |
| Hollow Glass Particles | “Glass Balloons GL-3” manufactured by Keiwa |
| | Rozai Co. Ltd. (hollow glass particles having an |
| | average particle diameter of 300 μm to 600 μm |
| | and a porosity of 84%) |
| Glass Particles | Glass particles having an average particle |
| | diameter of 300 μm to 500 μm fabricated in |
| | accordance with Fabrication Example 2 |
| Vulcanization | “Soxinol CZ” manufactured by Sumitomo |
| accelerator: | Chemical Co., Ltd. |
| Sulfur: | “Powdered Sulfur” manufactured by Tsurumi |
| | Chemical Industry Co., Ltd. |

### Fabrication Example 1: Foamed Glass Particles 1 and Foamed Glass Particles 2

A ball mill was used to pulverize “Porous α” (porous foamed glass) manufactured by Tottori Resource Recycling, Inc., and this was graded, to obtain Foamed Glass Particles 1 and Foamed Glass Particles 2. “Porous α” is soda-lime glass, the major components of which are SiO₂, CaO, and Na₂O. SiO₂ was 62.00%, CaO was 24.70%, and Na₂O was 8.6%. Besides SiO₂, CaO, and Na₂O, the constituents of “Porous α” include K₂O, Al₂O₃, Fe₂O₃, and so forth. “Porous α” was manufactured by a procedure in which discarded glass bottles are crushed, this is pulverized, this is mixed with powdered seashells serving as foaming agent, and this is fired.

### Fabrication Example 2: Glass Particles

A ball mill was used to pulverize discarded glass bottles, and this was graded to obtain Glass Particles.

### Calculation of Porosity of Foamed Glass Particles 1 and Foamed Glass Particles 2

$$Porosity [ \% ] = ( volume [ ml ] of pores ) / ( bulk volume [ ml ] of sample ) \times 100 = \{ ( bulk volume [ ml ] of sample ) - ( actual volume [ ml ] of sample ) \} / ( bulk volume [ ml ] of sample ) \times 100 = \{ 1 - ( actual volume [ ml ] of sample ) / ( bulk volume [ ml ] of sample ) \} \times 100 = \{ 1 - ( bulk specific gravity [ g \text{/} ml ] of sample ) / ( true specific gravity [ g \text{/} ml ] of sample ) \} \times 100$$

Here, the true specific gravity of glass was taken to be 2.5.

### Fabrication of Tires at the Various Examples

The compounding ingredients except for sulfur and vulcanization accelerator were added to rubber in accordance with TABLE 1, a Model B Banbury mixer manufactured by Kobe Steel, Ltd., was used to carry out mixing, and the rubber mixture was discharged. The rubber mixture was then mixed with sulfur and vulcanization accelerator in a Model B Banbury mixer to obtain unvulcanized rubber. A green tire employing the unvulcanized rubber as tread rubber was fabricated, and this was vulcanized to obtain a 185/65R14 tire. The tire was mounted on a 14×5.5 JJ wheel.

### Braking Performance on Ice

Four tires were mounted on a 2000-cc 4WD vehicle, and the braking distance with operation of ABS when traveling at a speed of 40 km/h on an ice-covered road surface (temperature −3°±3° C.) was measured (n=10 trials). Braking distances (averages of n=10 trials) of the respective Examples are shown as indexed relative to a value of 100 for the braking distance (average of n=10 trials) obtained at Comparative Example 1. The higher the index the shorter was the braking distance, and thus the better was the braking performance.

### Stability in Handling in Snow

To evaluate stability in handling, a driver responsible for sensory testing drove the 4WD vehicle through a snow test course at high speed while paying attention to steering wheel response, driving stability, and so forth. Stability in handling was compared to that of Comparative Example 1 to determine whether it was better, in which case it was taken to be +2; somewhat better, in which case it was taken to be +1; equivalent thereto, in which case it was taken to be ±0; somewhat worse, in which case it was taken to be −1; or worse, in which case it was taken to be −2.

### Wear Resistance

A 2000-cc 4WD vehicle was driven 10000 km, the tires being rotated between left and right sides every 2500 km, following which the remaining groove depth at the tread of the four tires was measured. The average value for each respective example is shown indexed relative to a value of 100 for the average remaining groove depth at the tread of the four tires. The higher the index the better it was in terms of wear resistance.

TABLE 1

| | | Comparative | Comparative | Comparative | Working | Working | Working | Comparative | Comparative | Working |
|---|---|---|---|---|---|---|---|---|---|---|
| | | Example 1 | Example 2 | Example 3 | Example 1 | Example 2 | Example 3 | Example 4 | Example 5 | Example 4 |
| Parts | Natural rubber | 50 | 50 | 50 | 50 | 50 | 50 | 50 | 50 | 50 |
| by mass | Butadiene rubber | 50 | 50 | 50 | 50 | 50 | 50 | 50 | 50 | 50 |
| | Carbon black | 25 | 25 | 25 | 25 | 25 | 25 | 25 | 25 | 25 |
| | Silica | 25 | 25 | 25 | 25 | 25 | 25 | 25 | 25 | 25 |
| | Coupling agent | 2 | 2 | 2 | 2 | 2 | 2 | 2 | 2 | 2 |
| | Paraffin oil | 20 | 20 | 20 | 20 | 20 | 20 | 20 | 20 | 20 |
| | Stearic acid | 2 | 2 | 2 | 2 | 2 | 2 | 2 | 2 | 2 |
| | Zinc oxide | 2 | 2 | 2 | 2 | 2 | 2 | 2 | 2 | 2 |
| | Antioxidant | 2 | 2 | 2 | 2 | 2 | 2 | 2 | 2 | 2 |
| | Wax | 2 | 2 | 2 | 2 | 2 | 2 | 2 | 2 | 2 |
| | Vegetative granules | — | 3 | — | — | — | — | — | — | — |
| | Porous cellulose | — | — | 3 | — | — | — | — | — | 2 |
| | particles | | | | | | | | | |
| | Foamed Glass | — | — | — | 3 | — | — | — | — | 3 |
| | Particles 1 | | | | | | | | | |
| | Foamed Glass | — | — | — | — | 3 | 10 | — | — | — |
| | Particles 2 | | | | | | | | | |
| | Hollow Glass | — | — | — | — | — | — | 3 | — | — |
| | Particles | | | | | | | | | |
| | Glass Particles | — | — | — | — | — | — | — | 3 | — |
| | Vulcanization | 1.5 | 1.5 | 1.5 | 1.5 | 1.5 | 1.5 | 1.5 | 1.5 | 1.5 |
| | accelerator | | | | | | | | | |
| | Sulfur | 2 | 2 | 2 | 2 | 2 | 2 | 2 | 2 | 2 |

| | | | | | | | | | |
|---|---|---|---|---|---|---|---|---|---|
| Braking performance on ice | 100 | 103 | 105 | 105 | 107 | 110 | 100 | 97 | 115 |
| Stability in handling in snow | Control | ±0 | ±0 | +2 | +1 | +1 | ±0 | −1 | +2 |
| Wear resistance | 100 | 98 | 98 | 110 | 105 | 103 | 93 | 95 | 110 |

Addition of foamed glass particles caused improvement in braking performance on ice, stability in handling in snow, and wear resistance. For example, addition of 3 parts by mass of Foamed Glass Particles 1 caused braking performance on ice to improve by 5 points, caused stability in handling in snow to become +2, and caused wear resistance to improve by 10 points (see Comparative Example 1 and Working Example 1).

Combined use of foamed glass particles and porous cellulose particles caused further improvement in braking performance on ice. For example, combined use of 3 parts by mass of Foamed Glass Particles 1 and 2 parts by mass of porous cellulose particles caused braking performance on ice to improve by 10 points (see Working Example 1 and Working Example 4).

1-9. (canceled)

10. A tire rubber composition comprising:
diene rubber; and
porous foamed glass particles;
wherein porosity of the foamed glass particles is not greater than 80%.

11. The tire rubber composition according to claim 10, wherein the foamed glass particles are present in an amount that is 0.5 part by mass to 20 parts by mass for every 100 parts by mass of the diene rubber.

12. The tire rubber composition according to claim 10, wherein average particle diameter of the foamed glass particles is less than 1000 μm.

13. The tire rubber composition according to claim 10, wherein the major foamed glass particle components are SiO₂, CaO, and Na₂O.

14. The tire rubber composition according to claim 10, further comprising at least one species selected from among the group consisting of pulverized porous carbide, porous cellulose particles, and vegetative granules.

15. The tire rubber composition according to claim 10, wherein the porosity of the foamed glass particles is not less than 56%.

16. The tire rubber composition according to claim 10, wherein the porosity of the foamed glass particles is not greater than 75%.

17. The tire rubber composition according to claim 10, wherein the foamed glass particles are present in an amount that is 1 part by mass to 15 parts by mass for every 100 parts by mass of the diene rubber.

18. The tire rubber composition according to claim 10, wherein average particle diameter of the foamed glass particles is not less than 5 μm but is less than 1000 μm.

19. The tire rubber composition according to claim 18, wherein the average particle diameter of the foamed glass particles is not greater than 500 μm.

20. The tire rubber composition according to claim 18, wherein the average particle diameter of the foamed glass particles is not less than 50 μm.

21. The tire rubber composition according to claim 18, wherein the average particle diameter of the foamed glass particles is not less than 100 μm.

22. A tire provided with a tread made up of the tire rubber composition according to claim 10.

23. A tire rubber composition manufacturing method comprising an operation in which porous foamed glass particles of porosity not greater than 80% fabricated using foaming agent comprising powdered seashells is kneaded into diene rubber.

24. The tire rubber composition manufacturing method according to claim 23, wherein at least inorganic waste material and the foaming agent serve as raw materials for the foamed glass particles.

25. A tire manufacturing method comprising:
an operation in which the tire rubber composition manufacturing method according to claim 23 is used to fabricate the tire rubber composition; and
an operation in which a green tire provided with a tread made up of the rubber composition is made.
